(19) United States
(12) Patent Application Publication
(10) Pub. No.: US 2009/0083280 A1
(43) Pub. Date: Mar. 26, 2009

(54) SYSTEM AND METHOD FOR GUIDING SIGHTSEERS

(75) Inventor: MING-FENG HSU, Tu-Cheng (TW)

Correspondence Address: PCE INDUSTRY, INC.;ATT. Steven Reiss, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 11/951,301

(22) Filed: Dec. 5, 2007

(30) Foreign Application Priority Data
Sep. 26, 2007 (CN) 200710201864.X

(51) Int. Cl. G06F 17/30; G06F 3/048

(52) U.S. Cl. 707/10; 715/200; 707/E17.032

(57) ABSTRACT

A method for guiding sightseers includes the steps of: providing at least one application server (20), each application server comprising a transreceiver (21) and a database (22); providing a handheld device (11), and searching for one or more active application servers in the wireless communication range of the handheld device; selecting an application server from the searched application servers, and establishing a wireless communication channel between the handheld device and the transreceiver of the application server; sending a data downloading request to the transreceiver through the wireless communication channel; receiving the data downloading request through the transreceiver and searching the database for data according to the data downloading request by the application server; transmitting the searched data to the handheld device through the transreceiver; and receiving the searched data transmitted from the application server. A system for guiding sightseers is also provided.

### BACKGROUND OF THE INVENTION

1. Field of the Invention

The present invention generally related to systems and methods for guiding sightseers.

2. Description of Related Art

Nowadays, most of the handheld devices, such as mobile phone, personal digital assistant (PDA) or palm computers may be equipped with a global positioning system. The global positioning system can facilitate positioning and navigating information to users. However, the position and navigation information may not include other information that may be beneficial to tourists and sightseers, information such as hotels, restaurants, museums, etc.

Accordingly, what is needed is a system and method, which can be accessible at anytime, for better sightseeing.

### SUMMARY OF THE INVENTION

One present embodiment provides a system for guiding sightseers. The system includes at least one application server and a handheld device, and where each application server includes a transreceiver and a database. The handheld device includes a searching module, a channel connecting module, a sending module, and a receiving module. The searching module is configured for searching for one or more active application servers in the wireless communication range of the handheld device. The channel connecting module is configured for selecting an application server from the searched application servers, and establishing a wireless communication channel between the handheld device and the transreceiver of the application server. The sending module is configured for sending a data downloading request to the transreceiver through the wireless communication channel. The application server receives the data downloading request through the transreceiver, and searches the database for data according to the data downloading request, and transmits the searched data to the handheld device through the transreceiver. The receiving module is configured for receiving the searched data transmitted from the application server for guiding sightseers.

Another present embodiment provides a method for guiding sightseers. The method includes the steps of: providing at least one application server, each application server comprising a transreceiver and a database; providing a handheld device, and searching for one or more active application servers in the wireless communication range of the handheld device; selecting an application server from the searched application servers, and establishing a wireless communication channel between the handheld device and the transreceiver of the application server; sending a data downloading request to the transreceiver through the wireless communication channel; receiving the data downloading request through the transreceiver and searching the database for data according to the data downloading request by the application server; transmitting the searched data to the handheld device through the transreceiver; and receiving the searched data transmitted from the application server for guiding sightseers.

Other systems, methods, features, and advantages will be or become apparent to one skilled in the art upon examination of the following drawings and detailed description.

### BRIEF DESCRIPTION OF THE DRAWINGS

FIG. 1 is a block diagram of a system for guiding sightseers in accordance with one preferred embodiment; and

FIG. 2 is a flowchart of a method for guiding sightseers in accordance with one preferred embodiment.

### DETAILED DESCRIPTION OF THE INVENTION

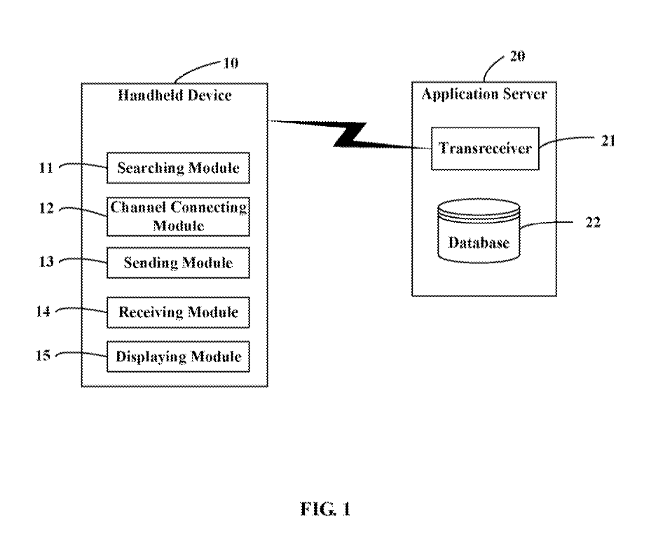

FIG. 1 is a block diagram of a system for guiding sightseers in accordance with one preferred embodiment. The system typically includes at least one application server 20 and a handheld device 10 to access the application server 20. The application server 20 includes a transreceiver 21 and a database 22. In another present embodiment, the transreceiver 21 and the database 22 may locate outside of the application server 20, and connect to the application server 20 externally. The database 22 includes detailed information of nearby tourist and other sightseeing destination with the associated map of the area.

The handheld device 10 is a wireless communication device configured for communicating with the application server 20 through a wireless communication connection with the transreceiver 21. The wireless communication connection between the handheld device 10 and the transreceiver 21 may be a Bluetooth connection, a Zigbee connection or a wireless local area network (WLAN) connection. The handheld device 10 may be a mobile phone, a personal digital assistant (PDA), a palm computer or any other portable client that can be used for wireless communication.

The handheld device 10 includes a searching module 11, a channel connecting module 12, a sending module 13, a receiving module 14 and a displaying module 15.

The searching module 11 is configured for searching for one or more active application servers 20 in the wireless communication range of the handheld device 10.

The channel connecting module 12 is configured for selecting an application server 20 from the searched application servers 20, and establishing a wireless communication channel between the handheld device 10 and the transreceiver 21 of the application server 20. The wireless communication channel is a Bluetooth channel, a Zigbee channel or a WLAN channel.

The sending module 13 is configured for sending a data downloading request to the transreceiver 21 through the wireless communication channel.

The application server 20 receives the data downloading request through the transreceiver 21, and searches the database 22 for data according to the data downloading request, and transmits the searched data to the handheld device 10 through the transreceiver 21. The data includes text data, sound data and video data. The content of the data includes detailed information of a nearby tourists or sightseeing attractions.

The receiving module 14 is configured for receiving the searched data that is transmitted from the application server 20.

The displaying module 15 is configured for displaying the searched data on a display screen (not shown) of the handheld device 10. The handheld device 10 needs to install corresponding software for displaying the searched data. For example, if the searched data is video data, the handheld device 10 needs to install a media player for displaying the video data.

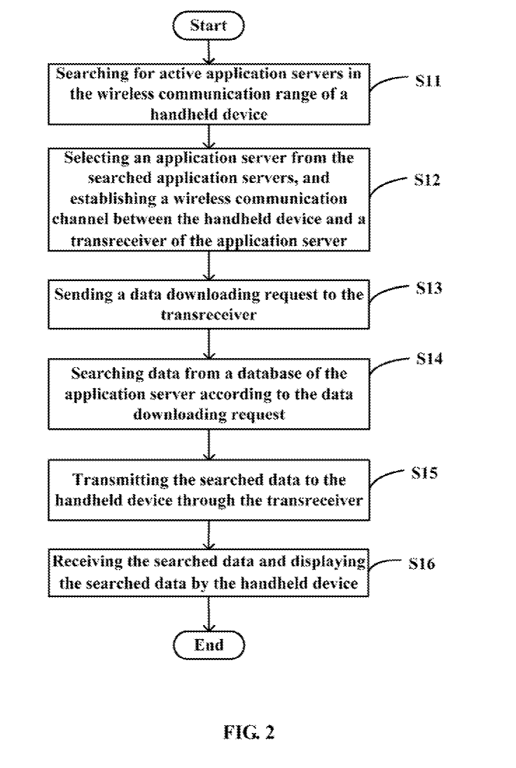

FIG. 2 is a flowchart of a method for guiding sightseers in accordance with one preferred embodiment.

In step S11, the searching module 11 searches for one or more active application servers 20 in the wireless communication range of a handheld device 10.

In step S12, the channel connecting module 12 selects an application server 20 from the searched application servers 20, and establishes the wireless communication channel between the handheld device 10 and the transreceiver 21 of the application server 20.

In step S13, the sending module 13 sends the data downloading request to the transreceiver 21 through the wireless communication channel. step S14, the application server 20 receives the data downloading request through the transreceiver 21, and searches the database 22 for data according to the data downloading request.

In step S15, the application server 20 transmits the appropriate searched data to the handheld device 10 through the transreceiver 21.

In step S16, the receiving module 14 receives the searched data transmitted from the application server 20, and the displaying module 15 displays the searched data on a display screen of the handheld device 10.

It should be emphasized that the above-described embodiments of the preferred embodiments, particularly, any “preferred” embodiments, are merely possible examples of implementations, merely set forth for a clear understanding of the principles of the invention. Many variations and modifications may be made to the above-described preferred embodiment(s) without departing substantially from the spirit and principles of the invention. All such modifications and variations are intended to be included herein within the scope of this disclosure and the above-described preferred embodiment(s) and protected by the following claims.

What is claimed is:

1. A system for guiding sightseers, the system comprising at least one application server and a handheld device, each application server comprising a transreceiver and a database, the handheld device comprising a searching module, a channel connecting module, a sending module, and a receiving module, wherein:
the searching module is configured for searching for one or more active application servers in the wireless communication range of the handheld device;
the channel connecting module is configured for selecting an application server from the searched application servers, and establishing a wireless communication channel between the handheld device and the transreceiver of the application server;
the sending module is configured for sending a data downloading request to the transreceiver through the wireless communication channel;
the application server receives the data downloading request through the transreceiver, and searches the database for data according to the data downloading request, and transmits the searched data to the handheld device through the transreceiver; and
the receiving module is configured for receiving the searched data transmitted from the application server for guiding sightseers.

2. The system according to claim 1, wherein the handheld device further comprising a displaying module for displaying the searched data on a display screen of the handheld device.

3. The system according to claim 1, wherein the wireless communication channel is a Bluetooth channel, a Zigbee channel or a WLAN channel.

4. A method for guiding sightseers, the method comprising the steps of:
providing at least one application server, each application server comprising a transreceiver and a database;
providing a handheld device, and searching for one or more active application servers in the wireless communication range of the handheld device;
selecting an application server from the searched application servers, and establishing a wireless communication channel between the handheld device and the transreceiver of the application server;
sending a data downloading request to the transreceiver through the wireless communication channel;
receiving the data downloading request through the transreceiver and searching the database for data according to the data downloading request by the application server;
transmitting the searched data to the handheld device through the transreceiver; and
receiving the searched data transmitted from the application server for guiding sightseers.

5. The method according to claim 4, further comprising the step of displaying the searched data on a display screen of the handheld device.

6. The method according to claim 4, wherein the wireless communication channel is a Bluetooth channel, a Zigbee channel or a WLAN channel.
